(19) United States
(12) Patent Application Publication
(10) Pub. No.: US 2007/0110256 A1
(43) Pub. Date: May 17, 2007

(54) AUDIO EQUALIZER HEADSET

(75) Inventors: Richard S. Slevin, Los Altos, CA (US); Michael R. Slevin, Campbell, CA (US)

Correspondence Address: MICHAEL E. WOODS;PATENT LAW OFFICES OF MICHAEL E. WOODS, 112 BARN ROAD, TIBURON, CA, 94920-2602, US

(73) Assignee: ODI, Mountain View, CA (US)

(21) Appl. No.: 11/164,310

(22) Filed: Nov. 17, 2005

(51) Int. Cl. H04R 1/10; H04M 1/00

(52) U.S. Cl. 381/74; 381/103; 455/575.2

(57) ABSTRACT

A headset, the headset including a communications module for receiving one or more electronic signals from an audio source, the one or more electronic signals representing an audio stream having a first element at a first audible frequency and a second element at a second audible frequency; a controller, communicated to the communications module, for generating a first element audiblizing signal from the first element and a second element audiblizing signal from the second element; and an equalizer, coupled to the controller, for modifying an output amplitude of the first audiblizing signal responsive to a user-modifiable equalizer data table without modifying an output amplitude of the second audiblizing signal.

### BACKGROUND OF THE INVENTION

The invention relates generally to frequency equalization of audio streams, and more specifically to user-customization of equalization of an incoming audio stream from a cellular telephone to a wireless headset operable with the telephone.

The current state of the art includes many solutions for frequency equalization of music streams. It is common to provide for frequency band equalizers as part of most stereo reproduction systems. In these systems, a desired frequency range is sub-divided into bands, and a control is provided for each band to modify an amplitude of music signals within the band. For these systems, these adjustments are primarily for aesthetics to modify the reproduced music to conform to personal preferences of the user.

These controllers are sometimes stand-alone components and other times incorporated into the music player. There are many music players—some are designed to be operated as part a system deployed in a room and others designed for portability, like personal tape, MP3, CD, satellite radio, and the like, that often use a headset for music reproduction.

Not all of these music sources, particularly the portable sources, incorporate such controllers so the benefits of the frequency equalization systems are unavailable. Additionally, for users that have multiple music sources, each must be independently adjusted to the user preferences, and when user preferences change, each must be independently modified.

There are other portable electronic devices that generate audio signals by use of headsets, such as cellular telephones. It is not uncommon for users to be conversing through a microphone-equipped headset when operating these telephones. Sometimes these telephones are operated in noisy environments increasing a difficulty of participating in these conversations using the headset.

Not only noisy environments contribute to increasing the difficulty of these conversations, but it is sometimes the case that some users have degraded or enhanced sensitivity to certain frequencies.

What is needed is a headset (and systems, methods, and computer program products) that incorporates frequency equalization to provide a user with an opportunity to adjust for personal preferences and/or personal degradations/sensitivities to one or more audio sources.

### BRIEF SUMMARY OF THE INVENTION

Disclosed is a headset, the headset including a communications module for receiving one or more electronic signals from an audio source, the one or more electronic signals representing an audio stream having a first element at a first audible frequency and a second element at a second audible frequency; a controller, communicated to the communications module, for generating a first element audiblizing signal from the first element and a second element audiblizing signal from the second element; and an equalizer, coupled to the controller, for modifying an output amplitude of the first audiblizing signal responsive to a user-modifiable equalizer data table without modifying an output amplitude of the second audiblizing signal.

Preferred embodiments of the present invention include systems, computer program products, and propagated signals for incorporating, implementing, making, and using this headset, for audio sources including portable electronic devices (music players and cellular telephones and the like) as well as traditionally non-portable (e.g., operate from line power) audio sources.

The preferred embodiments provide for a headset (and systems, methods, and computer program products) that incorporates frequency equalization to provide a user with an opportunity to adjust for personal preferences and/or personal degradations/sensitivities to one or more audio sources.

The novel features which are characteristic of the invention, as to organization and method of operation, together with further objects and advantages thereof, will be better understood from the following description considered in connection with the accompanying drawings in which one or more preferred embodiments of the invention are illustrated by way of example. It is to be expressly understood, however, that the drawings are for the purpose of illustration and description only and are not intended as a definition of the limits of the invention. These drawings include the following figures, with like numerals indicating like parts.

### BRIEF DESCRIPTION OF THE DRAWINGS

FIG. 1 is a generalized block diagram for a preferred embodiment of the present invention;

FIG. 2 is a detailed block diagram for a preferred embodiment of the headset shown in FIG. 1;

FIG. 3 is a generalized block diagram for a preferred embodiment of the headset in a configuration mode; and

FIG. 4 is a generalized flow diagram for a preferred embodiment of a configuration process.

### DETAILED DESCRIPTION OF THE INVENTION

The present invention relates to a headset (and systems, methods, and computer program products) that incorporates frequency equalization to adjust for personal preferences and/or personal degradations/sensitivities to one or more audio sources, using an interface to a controller (implemented for example by a local PC, a website, or over a telephone connection). The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

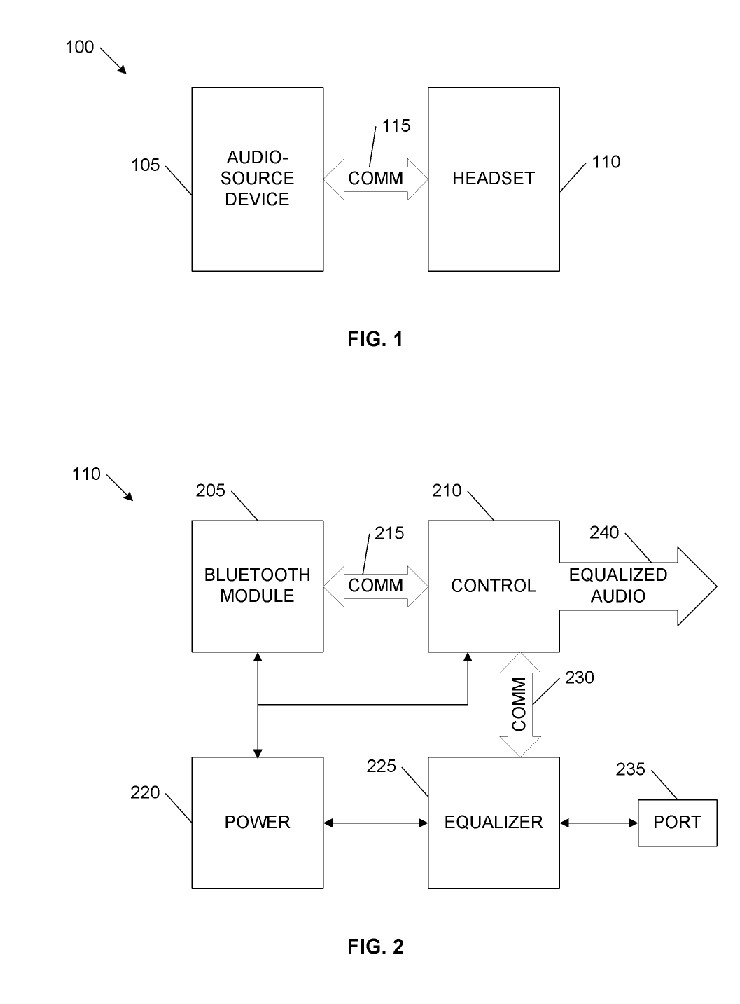

FIG. 1 is a generalized block diagram for a preferred embodiment of the present invention of an audio system 100. Audio system 100 includes an audio source device 105, a user-configurable equalizing headset 110, and a communications channel 115 coupling source 105 to headset 110. Device 105 includes portable electronic devices that produce data signals having audio components, such as for example mp3 players, radios, magnetic disk players, cellular telephones, and the like that use one or more batteries for power. Device 105 also includes apparatus operable with line power, such as through a power cord coupled to a power outlet.

Headset 110 includes an audio reproduction device, such a speaker or other audibilizing structure to convert the audio components of the data signals from device 105 into appropriate sound for a user. Headset 110 may include one such audio reproduction device (e.g., monaural) or multiple audio reproduction devices (e.g., stereo or surround sound). In some cases, headset 110 may include a microphone.

Communications channel 115 includes wired and wireless subsystems for communicating data signals from device 105 to headset 110 (and in some cases from headset 110 to device 105, such as when headset 110 includes the microphone for example). There are different protocols that may be used, including various wireless protocols including Bluetooth wireless communications protocol.

In operation of the preferred embodiment, system 100 includes a user-customizable equalizing function—in this preferred embodiment this function is disposed within headset 110—that provides for differing amplitude gain for audio components in different frequency bands. The equalizer function uses gain variables stored in non-volatile memory set using an external computing system to determine and configure as appropriate or desired. In this configuration, headset 110 will be desirably configured once and useable with multiple different devices 105 without requiring multiple configurations such as would be the case when the equalizing function is disposed in each of the multiple different devices. Other embodiments and implementations may dispose the external-computing-system configurable equalizer function in device 105 or in channel 115.

FIG. 2 is a detailed block diagram for a preferred embodiment of headset 110 shown in FIG. 1. Headset 110 includes a Bluetooth module 205, a controller (e.g., a control 210), a first internal communications channel 215, a power source 220, an equalizer function 225 communicated to controller 210 using a second communications channel 230, function 225 configurable through an externally accessible port 235 for controlling an equalized audio output stream 240, such as provided to the audio reproduction device(s) of headset 110.

In the discussion of FIG. 1, many different types of devices 105 and channels 115 were described. In the discussion of FIG. 2, a single specific exemplary configuration is described to simplify the discussion, the person of ordinary skill will appreciate that other configurations and implementations will be implemented to adapt headset 110 to other devices 105 and/or channels 115. Thus, device 105 is a cellular telephone equipped with a Bluetooth module for wireless Bluetooth communications over channel 115 as known in the art.

Module 205 is compatible with the protocol of channel 115 which in this example is the Bluetooth protocol. This is a standard module for receiving and transmitting data signals using the Bluetooth protocol. Control 210 is preferably a microcontroller that includes a central processor unit (CPU), memory for storing data (e.g., RAM) and program instructions (e.g., ROM or Flash) for implementing the desired functions of headset 110, and various other well-known resources for providing timing and input/output (I/O) interface communication. There are many different controllers that may be used, depending upon implementation and application details.

First communications channel 215 transfers data between module 205 and control 210 in well-known function, with power source 220 (e.g., a battery or energy cell) providing power for operation of components 110, including module 205, control 210, and function 225 when it is a distinct unit.

Equalizer function 225 is shown separate and distinct from controller 210 but in some embodiments this function may be integrated directly rather than as a stand-alone unit. Equalizer function 225 includes non-volatile memory (e.g., ROM or Flash) for storing a set of gain variables that correspond to different frequency bands, or ranges. A value of any particular gain variable influences an output amplitude of audio signals having frequency components within the particular band. The values of the gain variables are accessed by control 210 using second communications channel 230. The gain variables are used to modify the audio components in the data received over first communications channel 215 to adjust amplitude gain for elements within the particular bands when producing equalized audio output stream 240.

The user configures the specific values of the gain variables in equalizer function 225 using port 235. In the preferred embodiment, port 235 is a standard personal computer compatible interface, such as USB or Firewire or other communications protocol. In some implementations, a user may communicate with and configure equalizer function 225 using module 205, such as with suitably equipped personal computer systems or special configurators.

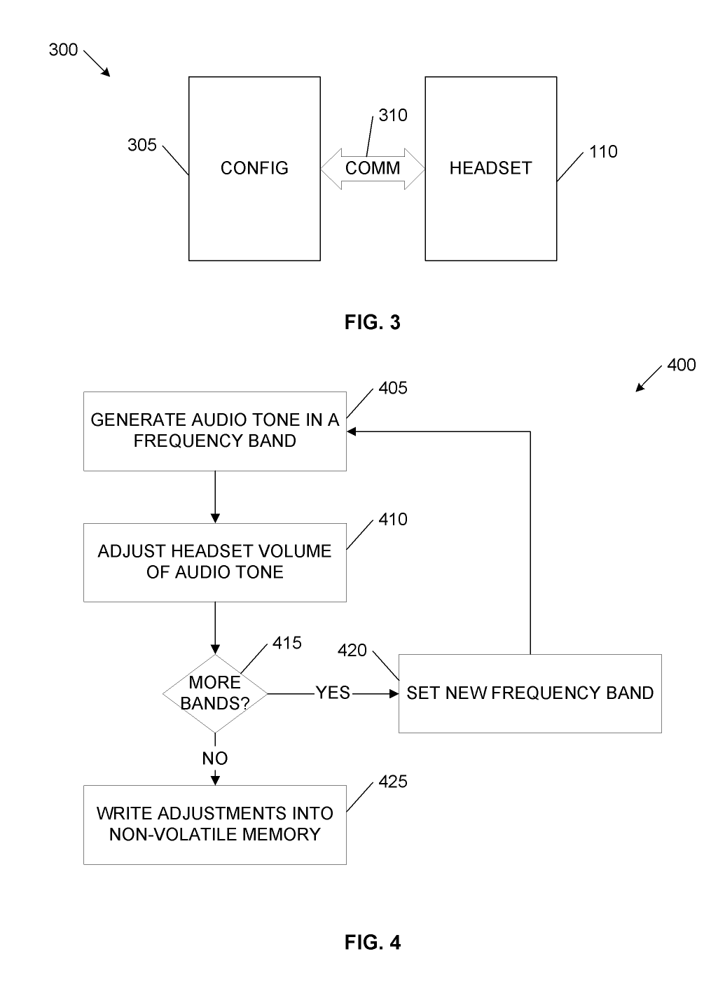

FIG. 3 is a generalized block diagram for a preferred embodiment of the headset in a configuration mode 300. Mode 300 includes a configuring system 305 (e.g., a PC, a website, an automatic response system access via telephone and the like) communicated to headset 110 using a configuration channel 310. As described above, system 305 communicates to headset 110 through port 235 or module 205.

In configuration mode 300, the user dons headset 110 and system 305 includes a user interface to control production of audio signals of desired frequencies to headset 110. The user employs the user interface to adjust appropriate gain variable values for the specific frequency being reproduced. When the gain variables have the desired values, the user operates the user interface to write the appropriate gain variable values into equalizer function 225. Thereafter headset 110 automatically adjusts the amplitude of the audio components from device 105 as appropriate based upon the gain variable values and the frequency of the audio components.

System 305 may be implemented in any of several different ways. A personal computing system may include a set of program instructions appropriate for tone generation, user interface response, and for writing gain variable values into headset 110. This set of program instructions may be distributed in a physical medium useable by the personal computing system or it may be accessible from a website (e.g., a secure website or public site). In some implementations the set of program instructions is configured to update other features of headset 110 (e.g., firmware updates, additional features and the like) in addition to setting gain variable values.

An alternative solution is to use an automatic response system accessible through a telephone line or other similar communications channel. For example, a user dons headset 110 and connects the headset to the telephone line using an adapter designed for this task. The user accesses the automatic response system by dialing a toll-free number, keying in an identifier for headset 110 (e.g., a serial number), and then respond to instruction prompts. The automatic response system generates a series of recorded messages and/or tones over a range of frequencies. Each time a desired audio signal been presented by the automatic response system, the user presses a key associated with a “SET” command. This is repeated for each band to be set and thereafter the automatic response system generates the set of gain variable values appropriate to that user. The set of gain variable values may be set in real-time over the telephone during operation or at the conclusion of the determining process. In some cases, the set of gain variable values may be sent later to an address associated with the serial number for off-line configuration (and other performance/firmware updates may also be provided). For purposes of this disclosure, such automatic response systems and other similar systems are included within the term computing system.

FIG. 4 is a generalized flow diagram for a preferred embodiment of a configuration process 400 implemented during configuration mode 300. Process 400 begins with step 405 wherein an audio tone is generated in a first frequency band. Next, step 410, process 400 adjusts a headset volume of the audio tone by setting a value for a gain variable applicable to the first frequency band.

Thereafter, process 400 tests at step 415 whether there are any additional frequency bands that are to be adjusted. When the test at step 415 is affirmative, process 40 branches to step 420 to set a new frequency band. Thereafter process 400 repeats step 405 through step 415 to generate an audio tone within the appropriate band, adjust an amplitude of the audio tone in this band, and test whether additional bands are to be adjusted. As long as the test at step 415 is affirmative, process 400 continues to cycle through step 420 and then to step 405 through step 415.

When the test at step 415 is negative, process 400 branches to step 425 instead of step 402. Step 425 writes the values for the gain variables as determined by step 405 through step 420 into non-volatile memory of headset 110.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, C#, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A system, comprising:
an audio source for providing one or more electronic signals representing an audio stream having a first element at a first audible frequency and a second element at a second audible frequency;
a communication subsystem for communicating said one or more electronic signals; and
a headset, in communication with said audio source using said communication system, said headset including:
a communications module for receiving said one or more electronic signals;
a controller, communicated to said communications module, for generating a first element audiblizing signal from said first element and a second element audiblizing signal from said second element; and
an equalizer, coupled to said controller, for modifying an output amplitude of said first audiblizing signal responsive to a user-modifiable equalizer data table without modifying an output amplitude of said second audiblizing signal.

2. The system of claim 1 wherein said audio source is a portable electronic device.

3. The system of claim 2 wherein said portable electronic device is a cellular telephone.

4. The system of claim 3 wherein said communications subsystem uses a wireless communications protocol.

5. The system of claim 4 wherein said wireless communications protocol is a Bluetooth protocol.

6. A headset, comprising:
a communications module for receiving one or more electronic signals from an audio source, said one or more electronic signals representing an audio stream having a first element at a first audible frequency and a second element at a second audible frequency;
a controller, communicated to said communications module, for generating a first element audiblizing signal from said first element and a second element audiblizing signal from said second element; and
an equalizer, coupled to said controller, for modifying an output amplitude of said first audiblizing signal responsive to a user-modifiable equalizer data table without modifying an output amplitude of said second audiblizing signal.

7. The headset of claim 6 wherein said audio source is a portable electronic device.

8. The headset of claim 7 wherein said portable electronic device is a cellular telephone.

9. The headset of claim 8 wherein said communications subsystem uses a wireless communications protocol.

10. The headset of claim 9 wherein said wireless communications protocol is a Bluetooth protocol.

11. A method, the method comprising:
a) generating a first audio tone in a first frequency band using a computing system communicated to a headset disposed in operation on a user;
b) adjusting an amplitude of said first audio tone using a first gain-controlling component of said headset; and
c) writing said first gain-controlling component to a non-volatile memory of said headset so that additional tones generated by said headset within said first frequency band thereafter use said first gain-controlling component.

12. The method of claim 111 further comprising:
d) generating a second audio tone in a second frequency band different from said first frequency band using said computing system;
e) adjusting an amplitude of said second audio tone using a second gain-controlling component of said headset; and
f) writing said second gain-controlling component to said non-volatile memory so that additional tones generated by said headset within said second frequency band thereafter use said second gain-controlling component.

13. The method of claim 11 wherein said computing system includes a local personal computer including a set of program instructions for generating said first tone.

14. The method of claim 13 wherein said computing system includes a remote computing system communicated to said local personal computer providing said set of program instructions.

15. The method of claim 11 wherein said computing system includes an automatic response system communicated to said headset using a telephonic communications channel.

16. A computer program product comprising a computer readable medium carrying program instructions for manufacturing a transport when executed using a computing system, the executed program instructions executing a method, the method comprising:
a) generating a first audio tone in a first frequency band using a computing system communicated to a headset disposed in operation on a user;
b) adjusting an amplitude of said first audio tone using a first gain-controlling component of said headset; and
c) writing said first gain-controlling component to a non-volatile memory of said headset so that additional tones generated by said headset within said first frequency band thereafter use said first gain-controlling component.

17. The computer program product of claim 13 further comprising:
d) generating a second audio tone in a second frequency band different from said first frequency band using said computing system;
e) adjusting an amplitude of said second audio tone using a second gain-controlling component of said headset; and
f) writing said second gain-controlling component to said non-volatile memory so that additional tones generated by said headset within said second frequency band thereafter use said second gain-controlling component.

18. The computer program product of claim 16 wherein said computing system includes a local personal computer including a set of program instructions for generating said first tone.

19. The computer program product of claim 18 wherein said computing system includes a remote computing system communicated to said local personal computer providing said set of program instructions.

20. The computer program product of claim 16 wherein said computing system includes an automatic response system communicated to said headset using a telephonic communications channel.
